(19) United States
(12) Patent Application Publication
(10) Pub. No.: US 2025/0255767 A1
(43) Pub. Date: Aug. 14, 2025

(54) WEARABLE EXOSKELETON DEVICE AND METHOD OF DONNING

(71) Applicant: The Catholic University of America, Washington, DC (US)

(72) Inventors: Rafael CASAS, Baltimore, MD (US); Peter LUM, Clarksburg, MD (US); Khue PHAN, Conroe, TX (US)

(21) Appl. No.: 19/052,439

(22) Filed: Feb. 13, 2025

Related U.S. Application Data
(60) Provisional application No. 63/553,363, filed on Feb. 14, 2024.

(51) Int. Cl. A61H 1/02

(52) U.S. Cl. CPC A61H 1/0288; A61H 2201/1638; A61H 2201/165; A61H 2201/1676; A61H 2201/5084

(57) ABSTRACT

A wearable device may include an exoskeleton configured to attach to a hand of a user, wherein the exoskeleton comprises one or more finger linkages for respective fingers of the hand. A finger attachment may be configured to slide onto each finger and attached to the respective one or more finger linkages. The one or more finger linkages comprises a metacarpophalangeal (MCP) joint linkage and proximal interphalangeal (PIP) joint linkage, wherein the one or more finger linkages couples the metacarpophalangeal (MCP) joint linkage and proximal interphalangeal (PIP) joint linkage together so that movement is restricted to one degree of freedom (DOF).

### CROSS-REFERENCE TO RELATED APPLICATIONS

This application claims benefit of priority of U.S. Provisional Patent Application No. 63/553,363 filed Feb. 14, 2024 entitled, “‘HandSOME II’ Exoskeleton.” The entire contents and disclosures of this patent application is incorporated herein by reference in their entirety.

This application makes reference to U.S. Provisional Patent Application No. 61/349,305, entitled “HAND SPRING ACTUATED MOVEMENT ENHANCER” filed May 28, 2010. The entire contents and disclosures of these patent applications are incorporated herein by reference.

### GOVERNMENT INTEREST STATEMENT

This invention was made with the United States government support under Grant number 90REGE0004 (RERC-DC) from the National Institute on Disability, Independent Living and Rehabilitation, Administration for Community Living of the U.S. Department of IHealth and Human Services. The government has certain rights in the invention.

### BACKGROUND

### Field of the Invention

The present disclosure relates generally to an exoskeleton device for medical rehabilitation. More particularly, the present disclosure relates to a portable, passively powered wearable exoskeleton device for the hand for stroke rehabilitation.

### Background of the Invention

There are approximately 800,000 new stroke cases every year in the US [1]. Fifty percent of affected individuals over the age of 64 show hemiparesis at six months and 26% of them are fully dependent on others for activities of daily living (ADL) [2]. Rehabilitation in the upper extremity targets reaching and grasping movements, but in order to use the upper limb for ADL, a high degree of motor control is needed. To complicate matters, hand motor control is commonly impaired, and the odds of regaining function are low [3]. Current therapy guidelines are to promote functional training of ADL for the affected arm and specialized task-oriented approaches that rely on repetitive practice [4].

Motor recovery of the paretic hand is a critical component for functional recovery in the upper limb [5]. Many stroke survivors have some degree of voluntary finger flexion; however, finger extension is limited by inappropriate activity in flexors [6] and inability to activate extensors [7]. By applying extension force to the fingers, exoskeletons can assist the effectiveness of task-related repetitive practice by enabling completion of their movements, increasing the effectiveness of task practice in the upper extremities [8]. A recent meta-analysis found that robotic devices provide larger gains in arm function, strength and ADL ability in comparison to other interventions [9]. Unfortunately, patients have limited access to robotic interventions because they are often too expensive for most clinics or individuals to purchase. In addition, most devices are not wearable for use during ADL, which limits transfer of gains to real world everyday use of the upper extremity [10]. Since hand use and object manipulation is the primary function of the upper extremity, task-specific training is required. Therefore, effective robotic devices should facilitate practice of complex multi-Degrees of Freedom (DOF) tasks involving the use of the hand to grasp and manipulate objects.

### SUMMARY

According to first broad aspect, the present disclosure provides a wearable device comprising: an exoskeleton configured to attach to a hand of a user, wherein the exoskeleton comprises one or more finger linkages for respective fingers of the hand; and a finger attachment configured to slide onto each finger and attached to the respective one or more finger linkages; wherein the one or more finger linkages comprises a metacarpophalangeal (MCP) joint linkage and proximal interphalangeal (PIP) joint linkage, wherein the one or more finger linkages couples the metacarpophalangeal (MCP) joint linkage and proximal interphalangeal (PIP) joint linkage together so that movement is restricted to one degree of freedom (DOF).

According to a second broad aspect, the present disclosure provides a wearable device comprising: an exoskeleton configured to attach to a hand of a user, wherein the exoskeleton comprises one or more finger linkages for respective fingers of the hand; and a finger attachment configured to slide onto each finger and attached to the respective one or more finger linkages; wherein the one or more finger linkages comprises a metacarpophalangeal (MCP) joint linkage and proximal interphalangeal (PIP) joint linkage, wherein the one or more finger linkages couples the metacarpophalangeal (MCP) joint linkage and proximal interphalangeal (PIP) joint linkage together so that movement is restricted to one degree of freedom (DOF), wherein the finger attachment comprises a quick-connect and quick-release function for connecting to the respective one or more finger linkages and/or disconnecting from the respective one or more finger linkages.

According to a third broad aspect, the present disclosure provides a method of donning a wearable device comprising: attaching an exoskeleton to a hand of a user, wherein the exoskeleton comprises one or more finger linkages for respective fingers of the hand; inserting fingers into a respective finger attachment; and connecting the finger attachment to the one or more finger linkages; wherein the one or more finger linkages comprises a metacarpophalangeal (MCP) joint linkage and proximal interphalangeal (PIP) joint linkage, wherein the one or more finger linkages couples the metacarpophalangeal (MCP) joint linkage and proximal interphalangeal (PIP) joint linkage together so that movement is restricted to one degree of freedom (DOF).

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1A illustrates a spring driven exoskeleton device with an open-handed configuration according to one embodiment of the present disclosure.

FIG. 1B illustrates the spring driven exoskeleton device of FIG. 1A grasping an object according to one embodiment of the present disclosure.

FIG. 1C graphically illustrates an MCP extension range in a typical subject wearing the spring driven exoskeleton device according to one embodiment of the present disclosure.

FIG. 1D illustrates a spring driven exoskeleton device with individual finger control according to one embodiment of the present disclosure.

FIG. 1E illustrates an evolution of hand exoskeletons according to one embodiment of the present disclosure.

FIG. 2 illustrates spring paths for MCP and PIP/DIP springs according to one embodiment of the present disclosure.

FIG. 3 is a graph illustrating typical torque vs. angle assistance curves for the MCP joint according to one embodiment of the present disclosure.

FIG. 4 illustrates locations of magnetometers and magnets during finger extension and flexion according to one embodiment of the present disclosure.

FIG. 5 illustrates an exoskeleton device providing extension assistance in order to grasp an object according to one embodiment of the present disclosure.

FIG. 6(a) illustrates linkages of an exoskeleton device what may be sized based on finger length according to one embodiment of the present disclosure.

FIG. 6(b) illustrates an exoskeleton device with prescribed locations of rubber bands (red lines) at the MCP and PIP joints according to one embodiment of the present disclosure.

FIG. 6(c) illustrates abnormal finger posture in a subject that is improved when wearing an exoskeleton device according to one embodiment of the present disclosure.

FIG. 6(d) graphically illustrates (Left) Theoretical MCP torque profiles with different spring path options. Full extension is 0 degrees, and the x-axis represents flexion angle. 8 rubber bands were used. Dashed lines represent theoretical spring length at the MCP; (Right) Calculated PIP torque profiles with “1 Pin” spring path option. Lines represent different rubber band count; Dashed line represent theoretical spring length at the PIP according to one embodiment of the present disclosure.

FIG. 6(e) graphically illustrates (Left) calculated MCP spring force profile (Right) calculated PIP spring force profile according to one embodiment of the present disclosure.

FIG. 6(f) graphically illustrates (Left) measured MCP torque profile with different spring path options using 8 rubber bands; (Right) measured PIP torque profile with 4 rubber bands according to one embodiment of the present disclosure.

FIG. 6(g) graphically illustrates a thumb piece of an exoskeleton device supporting CMC extension and CMC abduction according to one embodiment of the present disclosure.

FIG. 7 illustrates two different exoskeleton designs according to one embodiment of the present disclosure.

FIG. 8 illustrates a linkage component and an exoskeleton design (HandSOME II™—Torque Design) according to one embodiment of the present disclosure.

FIG. 9 illustrates another linkage component and another exoskeleton design (HandSOME II— Slider Design) according to one embodiment of the present disclosure.

FIG. 10 illustrates another linkage component and another exoskeleton design (HandSOME II— Low Profile Slider Design) according to one embodiment of the present disclosure.

FIG. 11 illustrates another linkage component and another exoskeleton design (HandSOME I with adjustable tension knobs) according to one embodiment of the present disclosure.

FIG. 12 illustrates coupling options in an exoskeleton design according to one embodiment of the present disclosure.

FIG. 13 illustrates range of motion for several thumb options in an exoskeleton design according to one embodiment of the present disclosure.

FIG. 14 illustrates different sensor combinations for exoskeleton designs according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For the purposes of the present disclosure, the term “exoskeleton” refers to a wearable device that helps a user move and perform tasks by increasing mobility and in some cases their strength. Exoskeletons can be used for a variety of purposes, including medical, military, and industrial applications. An exoskeleton may generally be considered to be a hard mechanical frame with joints that allow movement of the human operator. There are other types of exoskeletons that are softer and are worn on the body, supported by the internal skeleton of the human being. Exoskeletons may incorporate sensors that detect a user's intentions and movements. The sensors may be configured to send information to an onboard artificial intelligence (AI), which may predict the user's next move(s). Actuators may be employed as motors in the exoskeleton to drive the user's movements. Exoskeletons can help people with conditions that limit their mobility, such as spinal cord injuries, stroke, Parkinson's disease, and multiple sclerosis.

For the purposes of the present disclosure, the term “passive exoskeleton” refers to an exoskeleton that uses elastic components such as springs or elastic bands to apply force and torque to the body.

For the purposes of the present disclosure, the term “powered exoskeleton” refers to an exoskeleton that can be assistive or enhancing, and can help a user walk, lift heavy objects, improve flexibility, mobility or improve endurance. In some embodiments, the powered exoskeleton may be motor actuated and/or have a power source.

For the purposes of the present disclosure, the term “torque capacity” refers to the maximum level of torque that can be applied to the body segment.

For the purposes of the present disclosure, the term “wearable device” refers to a device that may be mounted, fastened or attached to a user or any part of a user's clothing, or incorporated into items of clothing and accessories which may be worn on the body of a user. In some embodiments, wearable device refers to wearable technology, wearables, fashionable technology, tech togs, fashion electronics, clothing and accessories, such as badges, watches, frames, exoskeletons, and jewelry and may incorporate computer and advanced electronic technologies.

### DESCRIPTION

While the invention is susceptible to various modifications and alternative forms, specific embodiment thereof has been shown by way of example in the drawings and will be described in detail below. It should be understood, however, that it is not intended to limit the invention to the particular forms disclosed, but on the contrary, the invention is to cover all modifications, equivalents, and alternatives falling within the spirit and the scope of the invention.

Powered hand exoskeletons that can be integrated into ADL practice have shown success in improving hand function of stroke patients [11]-[14]. However, the electronics, motors or pneumatic power sources of these devices result in increased weight, complexity and cost. Passive devices utilize spring or elastic elements for actuation, decreasing weight and eliminating the need for any electronic components and external power sources. Passive devices are better suited for home training, which enables increased ADL practice in real world environments. Home training has advantages because it reduces the need for therapist supervision and increases access to rehabilitation training, potentially increasing the dose available for highly motivated subjects. More practice and functional use of a stroke patient's affected limb offers more potential for clinical gains.

In the Saebo Flex™, metal springs are connected to the distal phalanx of each finger and can assist with hand opening and tone management therapy [15]. Due to the increasing extension force as the fingers are flexed, achieving full active range-of-motion is usually not possible and grasping small objects is difficult. Additionally, assistance is only provided for the proximal interphalangeal (PIP) joints, with movement at the distal interphalangeal (DIP) and metacarpophalangeal (MCP) joints restricted. In the Saebo Glove™, elastic bands provide extension assistance at the MCP and PIP joints, however this device cannot produce enough torque for patients with severe or moderate impairments. Another passive device, SCRIPT™ uses Saebo Flex™ components and achieves greater finger ROM by applying external extension torques with a combination of passive leaf springs and elastic tension cords [16].

Disclosed embodiments previously designed and tested the lightweight, passive, and portable handspring operated movement enhancer (HandSOME I™) exoskeleton device that was designed for pinch-pad grasp by bringing the pads of the thumb and fingers together. This device assists with ADL practice of grasping tasks but is designed as a neurorehabilitation retraining device. The device utilizes elastic cords for passive actuation of extensors. Its design assists finger and thumb coordination through a linkage that couples together movements of these digits. Studies showed improved ROM and functional grasp by individuals with stroke [17], [18]. A home training study found significant gains in hand function after 4 weeks of daily training [18].

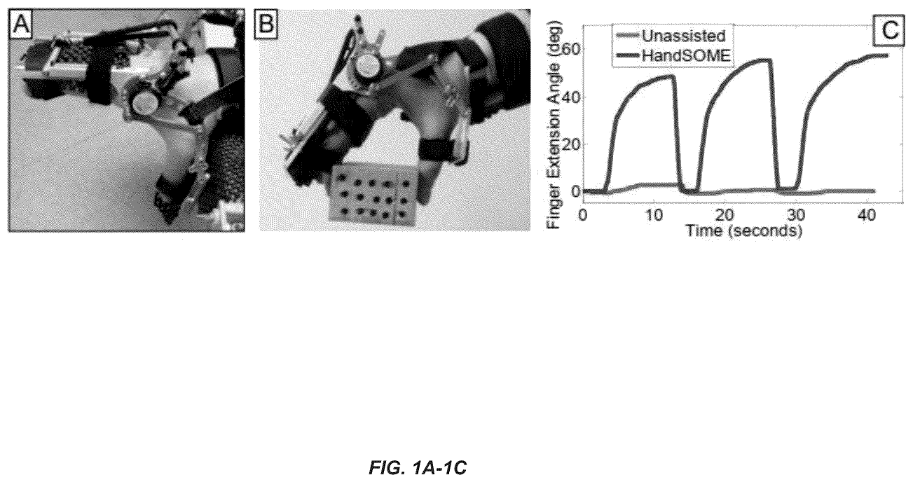

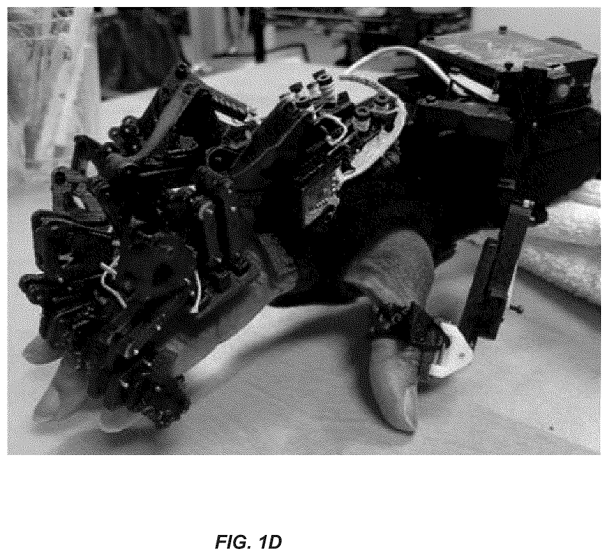

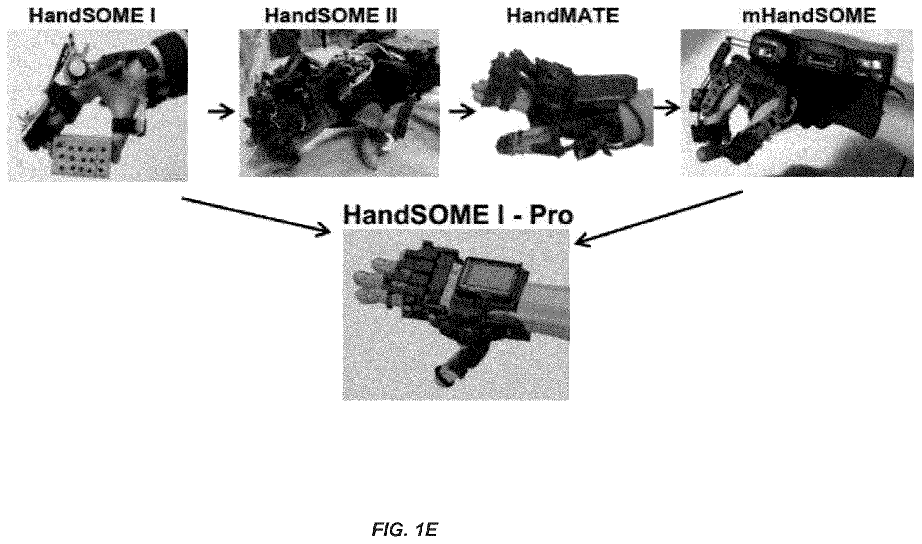

FIG. 1A illustrates a spring driven exoskeleton device with an open-handed configuration according to one embodiment of the present disclosure. FIG. 1B illustrates the spring driven exoskeleton device of FIG. 1A grasping an object according to one embodiment of the present disclosure. FIG. 1C graphically illustrates an MCP extension range in a typical subject wearing the spring driven exoskeleton device according to one embodiment of the present disclosure. FIG. 1D illustrates a spring driven exoskeleton device with individual finger control according to one embodiment of the present disclosure.

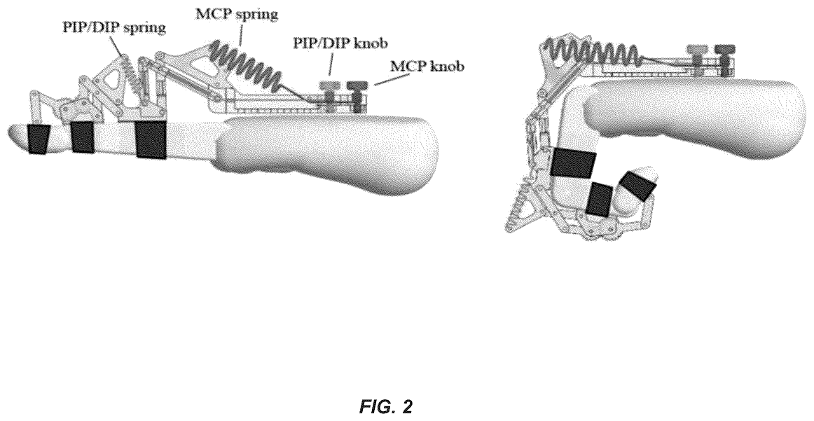

An improved exoskeleton device (FIG. 1D)—HandSOME II—expands the HandSOME I (FIGS. 1A-1C) concept, allowing customized adjustment of the extension assistance to 11 different finger joints and practice of more complex grasp patterns used in daily activities. The HandSOME I embodiment (FIGS. 1A-1C) couple's fingers together and also provides coupling of the MCP join and thumb. The HandSOME II (FIG. 1D) embodiment provides individual control of each finger. Thus, the HandSOME II (FIG. 1D) is comprised of rigid mechanical linkages that allow isolated movement at almost all finger and thumb joints. For each of the four fingers, a linkage is strapped to the dorsal surface of each phalange. The linkage has centers of rotation that align with the metacarpophalangeal (MCP) and proximal interphalangeal (PIP) joints allowing free movement. All of the rigid parts are on the back of the fingers to allow hand closing into a fist when there is no space between fingers. Eight steel coil springs provide extension torque at the MCP and PIP joints of the 4 fingers (FIGS. 1D and 2). The operating length of each spring can be adjusted by knobs, and this changes the peak assistance torque applied. If the distal interphalangeal (DIP) also needs extension support, the linkage can be extended with a gear and finger cap. The gear rotates the PIP and DIP together in a fixed ratio and both joints are driven together by one spring. For the thumb, a different linkage is attached that has joints aligned with the carpometacarpal (CMC) joint for abduction/adduction and flex/extension. Elastic bands were used to support CMC abduction, CMC extension and interphalangeal (IP) extension (if needed).

FIG. 1E illustrates an evolution of hand exoskeletons from the purely passive HandSOME family to the motorized HandMATE. HandSOME I and mHandSOME share structural design coupling movement of all fingers and thumb into 1 DOF.

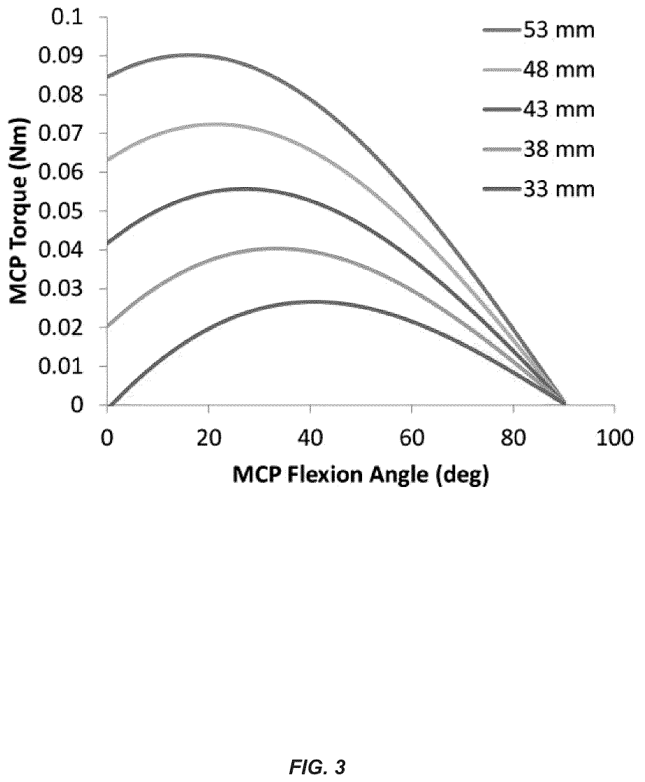

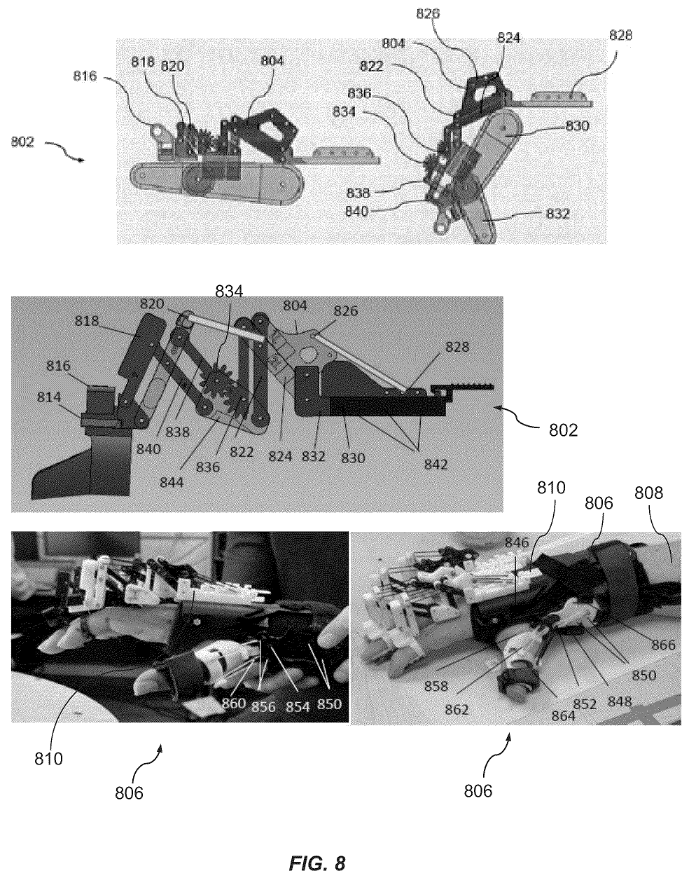

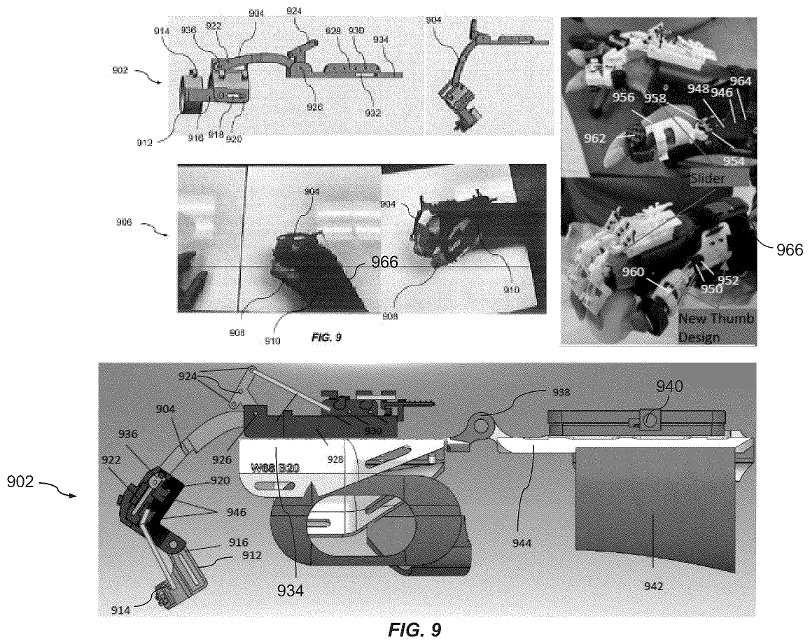

FIG. 3 shows the change in the assistance torque profile as the adjustment knob is adjusted. The shape and peak torque change as the maximum spring length denoted in the legend is adjusted with the MCP knob. Similar profiles were applied to the PIP joint. The torque capacity (peak torque) of the graph can be adjusted higher by selection of different elastic elements (as described below, for example with respect to prototypes described in FIGS. 8 and 9).

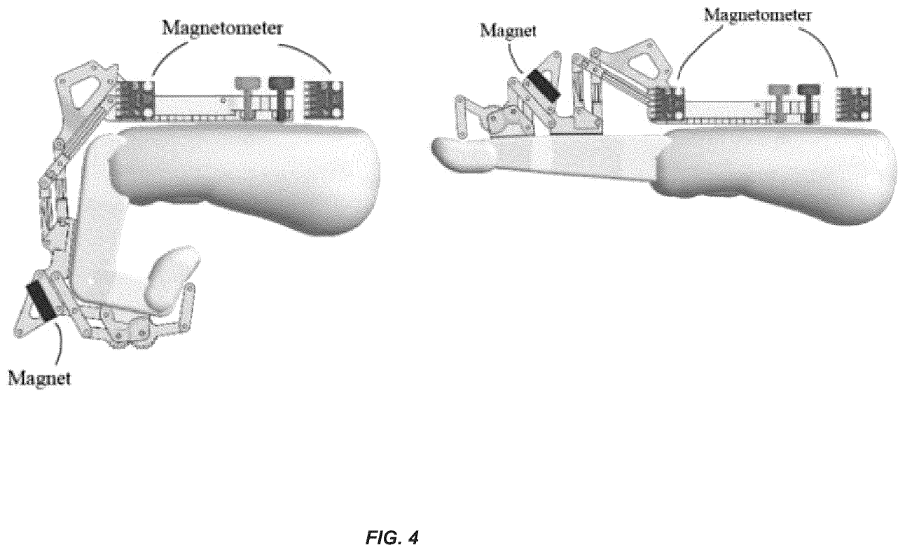

FIG. 4 illustrates locations of magnetometers and respective magnets during finger extension and flexion according to one embodiment of the present disclosure. The magnet orientation is affected by both MCP and PIP rotation. An activity tracker may be fully integrated into the disclosed exoskeleton device (such as HandSOME II) and collect index finger movement and the total time that the device is powered on (FIG. 4). When the tracker is turned on, motion data is automatically stored, such as, on an SD card. The tracker may consist of a pair of magnetometers, a permanent disc-shaped magnet attached to the index finger linkage, and a microcontroller with integrated SD card located on the back of the hand. Movement of the index finger MCP or PIP rotates the magnet relative to the magnetometers on the back of the hand. One magnetometer is close to the magnet and the other is far enough away to be only minimally affected by the magnet. The difference in the two magnetometer signals is used to detect finger movements. Whole arm and wrist movements also affect the magnetometers due to earth's magnetic field, but the effect is the same for both units and is removed by using the difference in the magnetometer signals. The accuracy of the activity tracker is validated with healthy controls and stroke subjects.

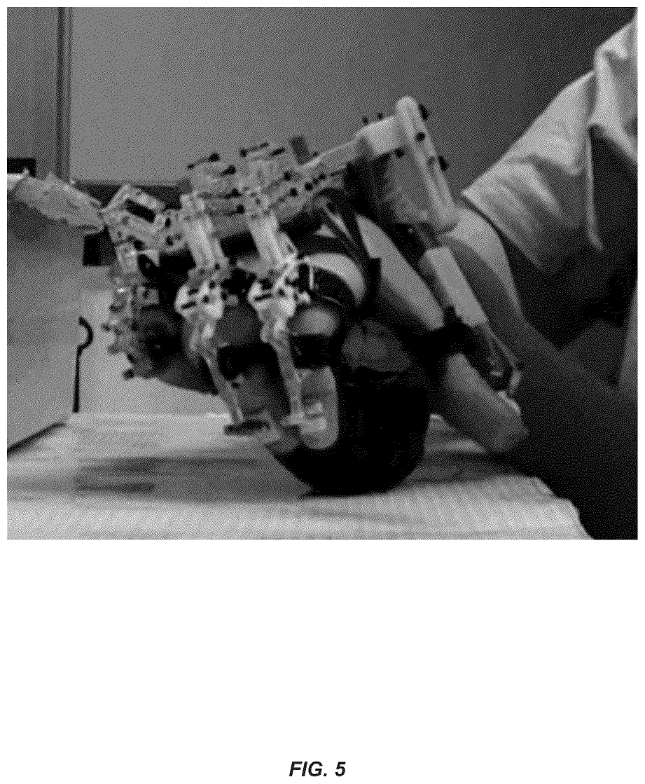

FIG. 5 illustrates an exoskeleton device providing extension assistance in order to grasp an object according to one embodiment of the present disclosure. Thus, the disclosed exoskeleton device, such as HandSOME II, expands the HandSOME concept to control more complex grasp patterns used in ADL [19](FIG. 1). As discussed, the disclosed exoskeleton device may be comprised of rigid mechanical linkages that allow isolated joint movement and elastic elements that provide customized extension assistance for each finger and thumb DOF. Each finger exoskeleton may be strapped to the finger segments and located on the back of the hand to avoid interference between fingers at a closed hand position. The linkages achieve centers of rotation aligned with the finger MCP and PIP joints to maximize comfort and proper kinematics.

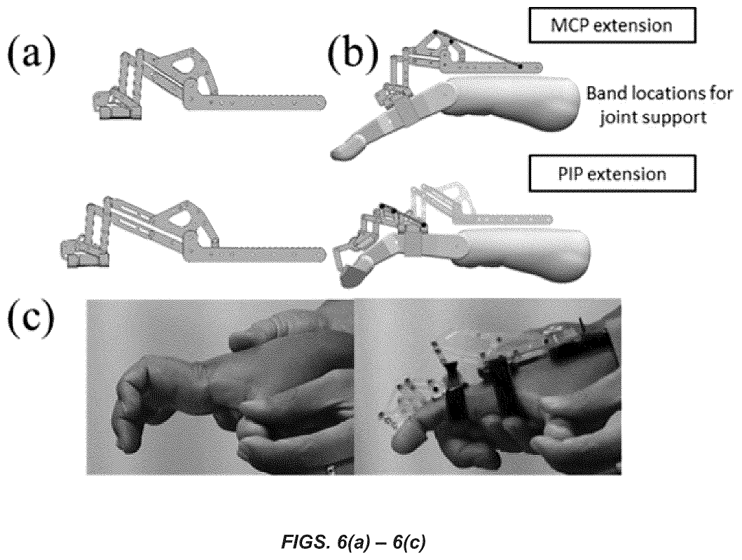

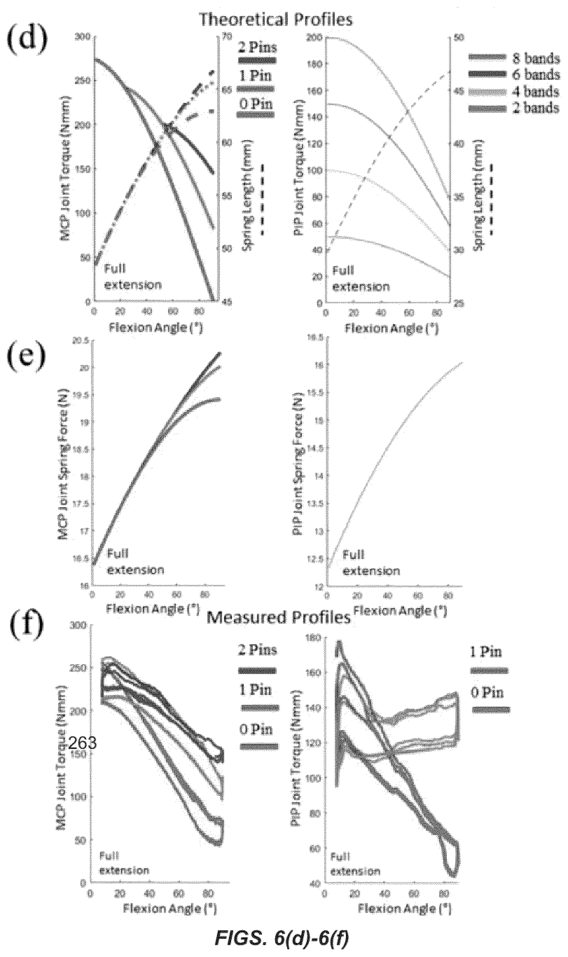

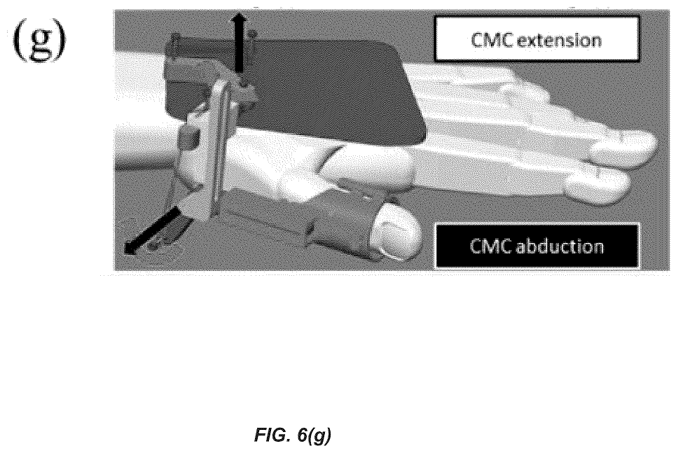

Linkages may be sized and adapted to subject's finger size (FIG. 6(a)). As seen in FIG. 6(b) and FIG. 6(c), adjustable elastic bands provide extension torque at the MCP and PIP joints. The disclosed exoskeleton device retains the characteristic used in HandSOME I of an adjustable assistance profile that decreases or remains constant as the flexion occurs. The amplitude of assistance is adjusted by adding rubber bands in parallel. The shape of the torque vs. angle assistance profile can be adjusted by use of optional wrapping “pins” that alter the path of the rubber bands and increase the torque in the fully flexed position (FIG. 6(d)). These pins are useful in cases where the rubber bands provide enough torque to hold the finger in full extension, but the fingers cannot be opened after a grasping movement. Rubber band stiffness is measured and found to be linear over the operating range (0.028 N/mm). This is used to calculate force profiles (FIG. 6(e)). Through benchtop testing, torque profiles are measured directly for MCP and PIP joint (FIG. 6(f)). Movement at the PIP and DIP are coupled together through a gear since they normally move synchronously. For the thumb (FIG. 6(g)), the carpometacarpal (CMC) joint has three DOFS: abduction/adduction, flex/extension and opposition/reposition. The mechanical design has DOFs for abduction/adduction and flex/extension. Separate elastic bands are used to support CMC abduction, CMC extension and interphalangeal (IP) extension. All parts may be laser cut acrylic plastic or 3D printed ABS plastic. Full details on the disclosed exoskeleton device including HandSOME II mechanical design are hereby incorporated in its entirety [19].

In application, engineers have fitted the disclosed exoskeleton device to a subject's hand and finger lengths. Different options for small, medium and large phalange lengths may be available. Spring tension may be adjusted based on a therapist's assessment and patient feedback. Different stiffness springs are available to accommodate subjects with difference impairment levels. Only the minimum spring assistance are given in order to keep the fingers extended or to functionally open to grip objects. The subjects are instructed on how to don the disclosed exoskeleton device and turn on the activity tracker before each of their home training sessions. Functional gains have been realized in treatment intensity 90-min sessions, five times a week. Thus, subjects are asked to perform a 90-min therapy session every weekday, for example, for 8 weeks, for a target of 60 h of wear time.

At weekly visits, for example, to a lab, adjustments and repairs may be made to the disclosed exoskeleton device, and the therapist may prescribe several grasp and release tasks with various objects, based on performance and individual goals. Subjects may also be encouraged to use the hand in everyday activities when wearing the disclosed exoskeleton device. The amount of movement practice during the weekly visits may be kept at a minimum, so that any gains may be attributed to the home training. Engineers may collect data from the activity logger SD card and troubleshoot or repair any broken parts at the therapist's direction. Spring tension may also be adjusted based on performance. At the end of 8 weeks, the sensor and logging electronics may be removed, and the disclosed exoskeleton device may be given to the subject. Subjects are encouraged to continue using the disclosed exoskeleton device during a 3-month follow-up, but there may be no formal scheduled contact with a project team until the end of the follow-up period, when subjects are called in for evaluations.

Present techniques recognize difficulties in donning some prior exoskeleton devices. In addition, some exoskeleton device designs may have limited torque capacity making the exoskeleton device not usable by patients, for example, with severe hypertonia in addition to some bulky appearances.

For example, the commercially available SaeboFlex® (Saebo Inc., Charlotte NC) is a exemplative passive hand rehabilitation device. However, SaeboFlex is intended for tone management and not intended for functional grasp of diverse objects, as it only allows for picking up objects 3-4 inches in diameter, and, therefore, smaller objects cannot be grasped. A newer product called SaeboGlove™ provides more degrees of freedom but is only appropriate for mild impairment.

In contrast, disclosed embodiments provide new mechanical designs to overcome, at least, the following challenges: 1) simplifying the exoskeleton design by reducing the number of parts, thereby decreasing cost and increasing commercial potential; 2) introducing a quick-release mechanism to make it easier to don the exoskeleton device; 3) providing a more compact low-profile design thereby increasing the aesthetic appeal of the exoskeleton device.

Thus, compared to the devices from Saebo, the mechanical design of the disclosed improved exoskeleton device is different. Both Saebo products rely on springs directly attached to the fingers to keep them extended, with increasing applied extension torque with increasing finger flexion, which makes it difficult to obtain and maintain full flexion, limiting range of motion and incurring fatigue in flexors. Whereas the disclosed exoskeleton device also uses springs, but the spring force is routed through a linkage, so that the applied extension torque allows a much larger range of motion. In a device that attaches elastic elements directly between a ground point and the finger segment, the torque applied will increase as the joint is flexed, requiring the patient to overcome this increasing torque as the hand is closed into a fist. The linkages used by our exoskeletons alter the profile such that the torque applied decreases as the fingers are closed, so the patient can complete the movement with less effort. This results in a larger range of motion as patients often have severe weakness when closing their hand. The available extension torque profiles are displayed in FIGS. 3 and 6.

### Quick-Release Component to Decrease Donning Time

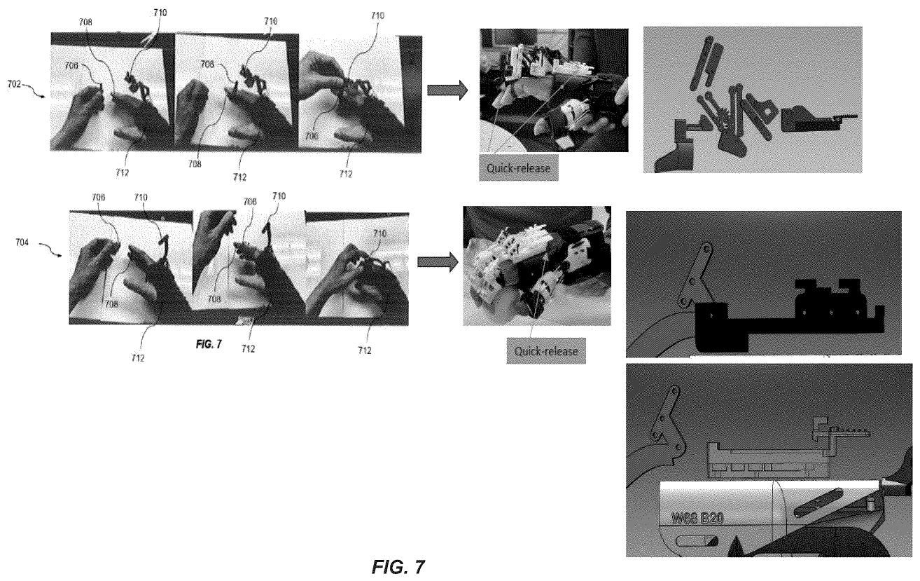

Some prior exoskeleton device designs, including, for example, Saebo devices use permanent elastic straps or finger caps to attach to the fingers. FIG. 7 illustrates two different exoskeleton designs 702 and 704 employing how a new donning procedure may work. Exoskeleton design 702 is a quick release-gear design and exoskeleton design 704 is a quick release-slider design. Exoskeleton design 702 is shown in FIG. 8 (802) and exoskeleton design 704 is in FIG. 9 (902). A fabric splint 712 may be provided to work in tandem with exoskeleton designs 702, 704. Exoskeleton design 702 is the high torque exoskeleton achieved by the mechanical coupling between MCP and PIP rotation. Exoskeleton design 704 does not couple MCP and PIP so separate elastic elements are used for the MCP and PIP rotation. Exoskeleton design 704 also replaces the complex linkage in exoskeleton design 702 with a simplified version that has fewer parts and is easier to manufacture. In exoskeleton designs 702, 704, a finger ring with release 706 is slid onto each finger at distal phalange 708 and snaps into place on one or more linkage types such as locking mechanism 710 of exoskeleton device via one or more snaps disposed, for example, along locking mechanism 710. Removal of ring-like finger attachment 706 may occur by unsnapping it from linkage types 710. Thus, finger ring with release 706 comprises a quick-connect and quick-release function for connecting to locking mechanism 710 and/or disconnecting from locking mechanism 710. While finger ring with release 706 is described as snapping to or unsnapping from locking mechanism 710, it is readily appreciated that other quick-connect and quick-release features may be employed to quickly and easily secure finger ring with release 706 to and/or from locking mechanism 710 (such as magnets, hook and loop fastener straps, or any other mechanism sufficient for easily attaching and detaching the disclosed components). Release of the connection is achieved by applying pressure to a specific location on finger ring with release 706 and/or locking mechanism 710.

### Prototype I

FIG. 8 illustrates view 802 of a linkage component 804 and a view 806 a user 808 wearing an exoskeleton device 810 employing linkage component 804 in one exemplary designed assembly. The disclosed first prototype exoskeleton device 810 provides increased torque capacity and couples the MCP and PIP rotations.

FIG. 8 illustrates gear linkage design 802, MCP rotation linkage 804 with attachment points, soft splint 806, quick release base 814, ring with quick release 816, linkage 1 (818) for PIP rotation, linkage 2 (820) for PIP rotation, linkage 1 (822) for MCP rotation, linkage 2 (824) for MCP rotation, hooks 826 for MCP band, hooks 828 for MCP band (part of retractable finger base with safety stop (for hooks 826 for MCP band)), finger base 830 with snap clip, retractable finger base 832 with safety stop for hooks 826 for MCP band, first gear 834 for coupling PIP, second gear 836 for coupling MCP, linkage 3 (838) for PIP rotation with gear, linkage 4 (840) for PIP rotation with gear, attachment points 842, gear coupling housing 844, hardtop 846, thumb ground base 848, thumb ground base 850 (ground points), thumb rotational 1 (852), thumb rotational 1 axis 854, thumb rotational 1 proximal thumb hooks 856, thumb rotational 2 858, thumb rotational 2 axis 860, thumb rotational 2 distal thumb hooks 862, thumb strap 864, and slots for hook and loop fastener straps 866.

The torque capacity is only limited by the number and type of elastic elements used. The appropriate torque capacity depends on each patient, which varies widely. For rubber bands, they can be added in parallel (torque from individual bands add together) until just the right amount of torque is applied to open the hand. Prior art uses an elastic element that cannot be adjusted or can be adjusted by extending the elastic element's ground point. This method of increasing torque does not provide the torque profiles shown in FIGS. 3 and 6. This disclosed prototype exoskeleton device 810 uses elastic bands between hooks 826 for MCP band and hooks 828 for the finger linkages MCP rotation linkage 804, linkage 1 (822), linkage 3 (838), linkage 4 (840) and couples the MCP and PIP linkages together, so that movement is restricted to one DOF. This allows the elastic bands for the MCP to drive both the MCP and PIP together.

Elastic bands provide extension torque at the MCP and PIP joints of the four fingers. Peak torque is limited only by the number of bands that can be placed in parallel. Disclosed embodiments may use the small elastic bands such as those utilized in orthodontics, which are inexpensive, and may be readily available commercially; some embodiments may employ elastic bands in several different thicknesses and stiffnesses. The bands are rated by peak force and range up to 6.5 oz and are typically ¼ inch in diameter. Larger diameter bands not used in orthodontics can also be used with force levels that exceed 1 lb. Thus, the torque capacity (peak torque) can be adjusted higher by selection of different elastic elements. Since MCP bands are at the back of the linkage, there is more space, and disclosed embodiments may reincorporate wrapping pins that change the shape of the assistance torque profile. The wrapping pins alter the torque profile so that higher levels of torque are available when the hand is closed as shown in FIG. 6d, which may be appropriate for some patients.

The exoskeleton design (HandSOME II—Torque Design) of FIG. 8 illustrates elastic band attachment points for linkage 2 (820) and linkage 2 (824) for extension assistance at the PIP. A second band is between component hooks 826 and hooks 828 for MCP extension assistance for each finger. FIG. 8. Illustrates linkage component finger base 830 is attached to hardtop 846 through screw holes at attachment points 842 at the bottom of the component.

FIG. 8 illustrates thumb linkage components (thumb ground base 848, thumb ground base 850 (ground points), thumb rotational 1 (852), thumb rotational 1 axis 854, thumb rotational 1 proximal thumb hooks 856, thumb rotational 2 858, thumb rotational 2 axis 860, thumb rotational 2 distal thumb hooks 862, thumb strap 864, and slots for hook and loop fastener straps 866) with 2 rotational points (thumb rotational 1 axis 854, thumb rotational 2 axis 860) and two sets of hooks (thumb rotational 1 proximal thumb hook 856, thumb rotational 2 distal thumb hooks 862) to provide extensional assistance through bands.

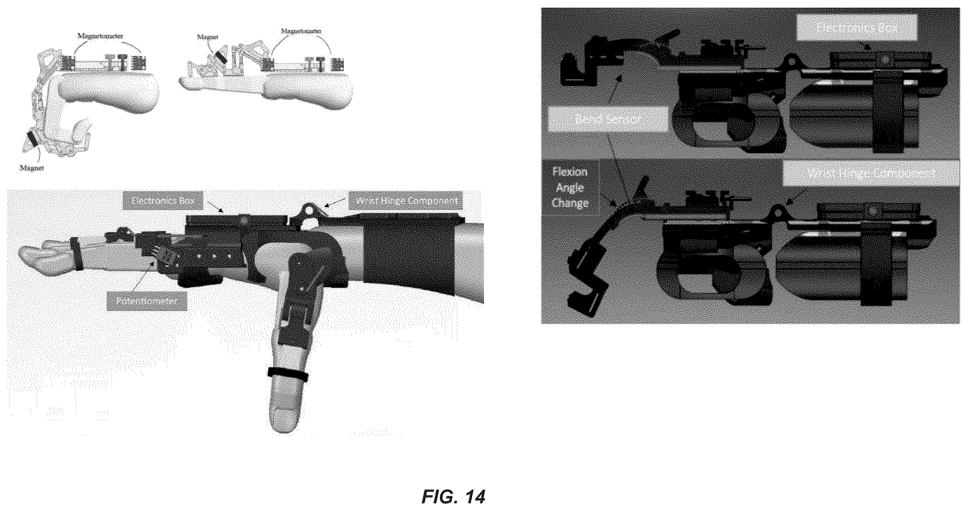

FIG. 14 illustrates different sensor combinations for exoskeleton designs according to one embodiment of the present disclosure. In some disclosed embodiments, sensor combinations may include one or more magnetometers, accelerometers, potentiometers, and/or bend sensors.

### Prototype II

FIG. 9 illustrates another linkage component and another exoskeleton design (HandSOME II—Slider Design) according to one embodiment of the present disclosure. FIG. 9 illustrates a slider linkage design 902 of a slider arm 904 and a view 906 a user 908 wearing another exoskeleton device 910 employing slider arm 904 in one exemplary designed assembly. The second prototype offers a simplified low-profile design. The prior exoskeleton device HandSOME II finger linkage design has 11 parts and 14 pin joints per finger. Assembly requires fairly precise manufacturing and skill to assemble. Also, the structure can appear bulky and cumbersome. For commercialization, a simpler, lower profile design is desirable for aesthetics and easier fabrication. Disclosed embodiments have developed a finger linkage component as slider arm 904 that has thin structures between the fingers and reduces the complexity to 4 parts and 3 pins per finger. In this design, simplicity is achieved with a physical pin at the PIP and a sliding joint for the MCP, with separate elastic bands used for these two joints. This simplified design represents a compromise in that full flexion to a fist is not possible with the structures between the fingers. Friction from the sliding pin could also be a problem, but the advantages are a lower profile and much easier assembly. Improved fabrication methods should reduce friction and not require use of a linear bearing which would increase costs and weight.

Distal rings 912 may be disposed around middle phalanges. Distal rings 912 may also be placed at a PIP joint for extension of distal phalanges. Additionally, FIG. 9 illustrates hooks 914 for band attachments, arms 916 of distal rings 912. Arms 916 may attach to element 920 at the PIP joint. Slots 918 are provided for attaching elastic straps. Element 920 attaches to distal rings 912 at the joint which may straps around the proximal phalange. Element 920 may also employ a slider track at the top. Slider track 922 is provided with a sliding pin 936 on the front end that slides across element 920. On the back end are attachment screws/hooks 924. Bands attach from points at screws/hooks 924 to material base 928. Multiple bands can be attached here or attached to a further point. Wrapping pins can also alter the torque profile. A connection point 926 may be provided along slider arm 904 to allow rotation in alignment with the MCP joint. Material base 928 has multiple attachment points 930 for bands between material base 928 and attachment screws/hooks 924. A securement strap such as hook and loop fastener straps may be provided through slot 932 to strap the exoskeleton device down to soft splint 966. Soft Splint 966 may comprise a thumb linkage and/or soft fabric wrist splint.

Disclosed embodiments may further provide top piece 934 (base of Part 1), sliding pin 936, wrist hinge 938, electronics box 940, wrist sleeve 942, wrist top piece 944, thumb ground base 946, thumb ground base-anchor points 948, thumb rotational 1 (950), thumb rotational 1 axis 952, thumb rotational 1 proximal thumb hooks. 954, thumb rotational 2 (956), thumb rotational 2 axis (958), thumb rotational 2 distal thumb hooks 960, thumb strap 962, slots for hook and loop fastener straps 964.

FIG. 9 illustrates elastic band attachment points (hooks 914, thumb ground base 946) for PIP rotation and MCP Rotation (screws/hooks 924, attachment points 930). The torque capacity (peak torque) can be adjusted higher by selection of different elastic elements. For PIP rotation, bands may be attached to component distal rings 912 and element 920 for each finger. For MCP rotation band is attached to component slider arm 904 and material base 928 for each finger. In one embodiment, material base 928 is attached to top piece 934 (hardtop) such as by screw holes and threaded fasteners at the bottom of material base 928. In another disclosed embodiment, the thumb linkage component is similar to the one for Prototype 1 and FIG. 8. Detailed components are labeled in FIG. 9.

### Prototype III

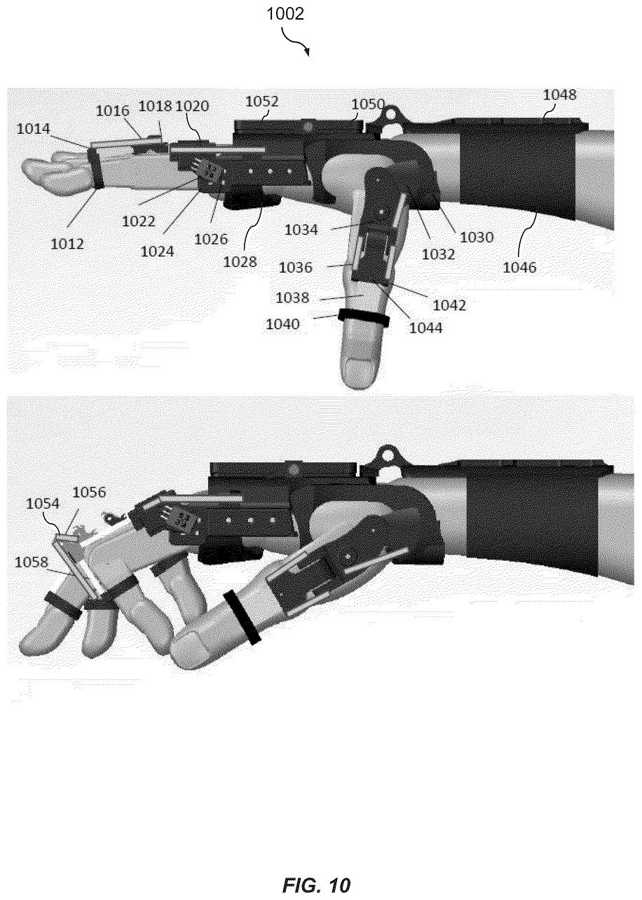

FIG. 10 illustrates another linkage component and another exoskeleton design (HandSOME II—Low Profile Slider Design) 1002 according to one embodiment of the present disclosure. Exoskeleton design (HandSOME II—Low Profile Slider Design) 1002 may employ linkage components. This third prototype offers a more low-profile design (than Prototype 2) and reduces bulkiness by eliminating the rigid material between the fingers. One distal strap is used (similar to prototype 1). In the disclosed design, the slider is now used for PIP Rotation. MCP finger joints are coupled (like HandSOME I) and reduces the need for accurate MCP joint locations to, thereby, simplify fitting. This design also allows coupling of thumb and MCP joint (similar to HandSOME I). This finger linkage design has 11 parts and 14 pin joints per finger. In the disclosed design, simplicity is achieved with a physical pin at the PIP and a sliding joint for the MCP, with separate elastic bands used for these two joints. Friction from the sliding pin could also be a problem, but the advantages are a lower profile and much easier assembly. Improved fabrication methods may reduce friction and not require use of a linear bearing which would increase costs and weight. The thumb linkage component is similar to the one for Prototype 1. FIG. 10 illustrates use of potentiometer for MCP reading.

Disclosed embodiments of exoskeleton design (HandSOME II—Low Profile Slider Design) 1002 may include distal finger strap 1012, strap attachment and hooks 1014, metal strip holder 1016, metal strip holder 1018, rotation part 1020 (having e.g., band attachment and/or strap attachment), potentiometer 1022, top piece with rotational points 1024, coupling hole 1026, strap across palm 1028, fabric sleeve 1030 with hook and loop fastener strap, thumb ground 1032, fabric elastic rings 1034, band hook 1036, metal strip 1038 (elongated and/or swappable), fabric elastic rings 1040, band hook 1042, metal strip fastening location 1044, wrist sleeve 1046, wrist top piece 1048, electronics box 1050, metal strip 1052 (elongated or swappable), fabric elastic rings 1054, PIP rotation point 1056, and metal finger strip 1058.

### Prototype IV

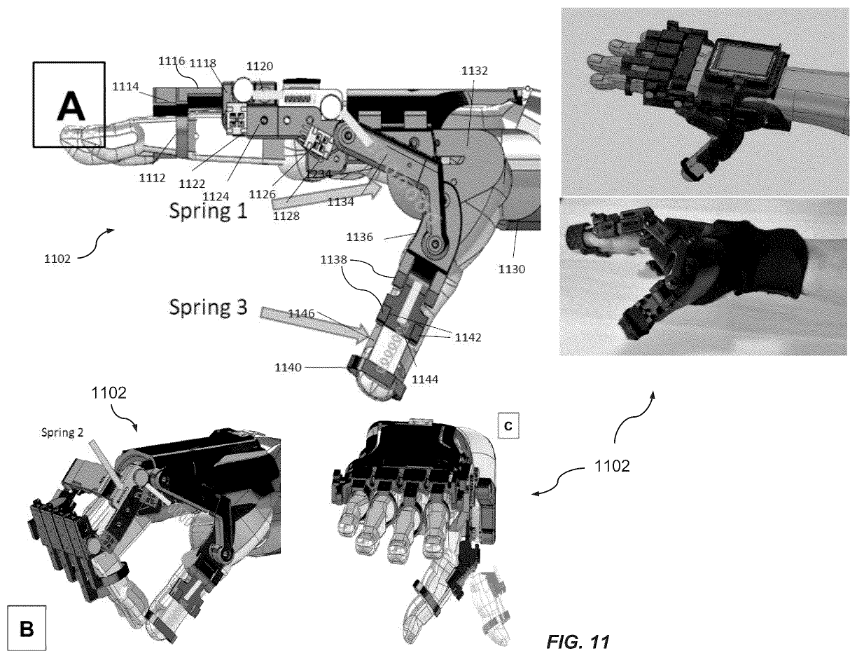

FIG. 11 illustrates another linkage component and another exoskeleton design (HandSOME I with adjustable tension knobs) according to one embodiment of the present disclosure. FIG. 11 illustrates a view of another exoskeleton device 1102 employing linkage components in a designed assembly. The fourth prototype is similar to prototype 3 but couples the PIP fingers instead of individual linkage (like HandSOME I). This offers the ability for linkage to couple PIP with MCP. Additionally, it offers to measure PIP movements with a potentiometer/encoder. The thumb design is similar to Prototype 3 and 4. It is coupled with linkage that can be length adjusted.

Disclosed embodiments of exoskeleton design (HandSOME I with adjustable tension knobs) 1102 may include distal finger strap 1112, strap attachment 1114, finger strip 1116, finger strip holder 1118 with PIP rotation and coupling point (for all 4 fingers), coupling point 1120, adjustment 1122 for table length arms with band hooks, fastening points 1124 to elongate, rotation and fastening point 1126, top piece 1128 with rotational points and coupling point, wrist sleeve 1130, thumb ground 1132, coupling piece 1134 (adjustable length), rotation thumb piece 1 (1136), rotation thumb piece 2 (1138), fabric elastic ring 1140, band hook 1142, metal strip fastening location 1144, and metal strip/elongated or swappable 1146.

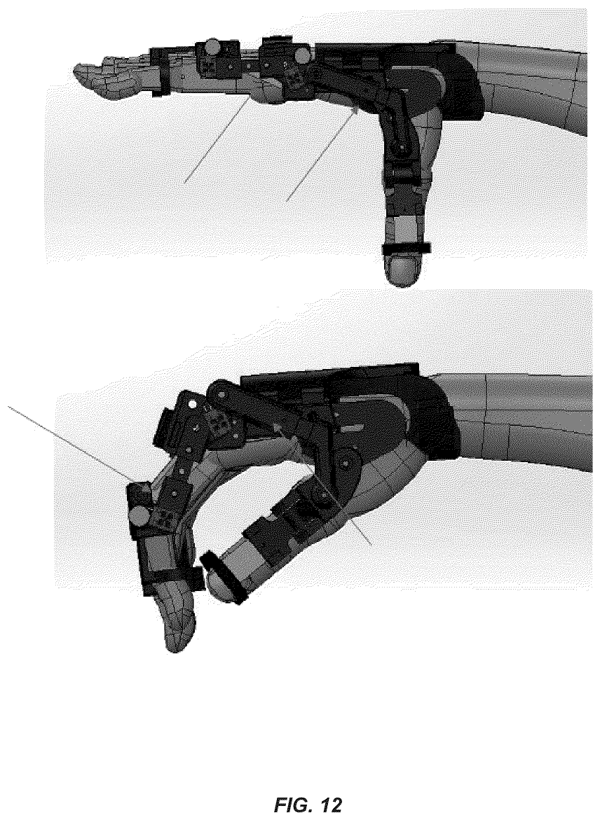

FIG. 12 illustrates coupling options in an exoskeleton design according to disclosed embodiments. Thus, in one embodiment a coupling option includes MCP/PIP. In another embodiment, the coupling option is between the thumb and MCP.

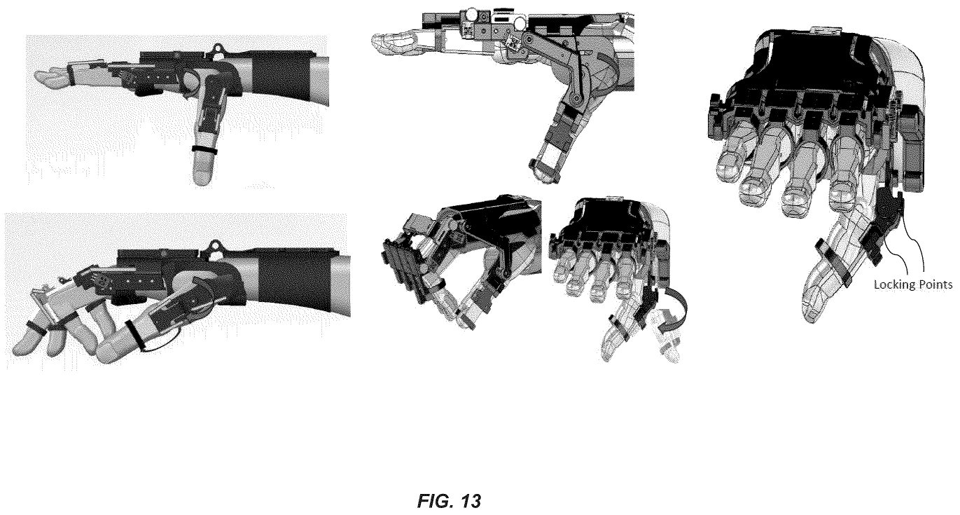

FIG. 13 illustrates range of motion for several thumb options in an exoskeleton design according to one embodiment of the present disclosure. The disclosed exoskeleton design may include thumb options available for HandSOME devices including for ROM and static positions.

FIG. 14 illustrates different sensor combinations for exoskeleton designs according to one embodiment of the present disclosure. Disclosed embodiments may employ different sensor combinations that include, for example, one or more magnetometer, accelerometer, potentiometer, and bend sensors (for determining flexion angle change). Some disclosed embodiments may incorporate an electronics box to house, for example, associated electrical components; structural designs such as a wrist hinge component, and measurement devices such as a potentiometer.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### REFERENCES

The following references are referred to above and are incorporated herein by reference:
1. Benjamin E J et al., “Heart disease and stroke statistics—2018 update: A report from the American heart association,” Circulation, vol. 137, no. 12, pp. e67-e492, 2018.
2. Roger V L et al., “Heart disease and stroke statistics-2012 update: A report from the American heart association,” Circulation, vol. 125, no. 1, pp. e67-e492, 2012.
3. Kwakkel G, Kollen B J, van der Grond J, and Prevo A J H, “Probability of regaining dexterity in the flaccid upper limb: Impact of severity of paresis and time since onset in acute stroke,” Stroke, vol. 34, no. 9, pp. 2181-2186, September. 2003.
4. Timmermans A A, Seelen H A, Willmann R D, and Kingma H, “Technology-assisted training of arm-hand skills in stroke: Concepts on reacquisition of motor control and therapist guidelines for rehabilitation technology design,” J. Neuroeng. Rehabil, vol. 6, no. 1, p. 1, December. 2009.
5. Kwakkel G and Kollen B, “Predicting improvement in the upper paretic limb after stroke: A longitudinal prospective study,” Restorative Neurol. Neurosci, vol. 25, nos. 5-6, pp. 453-460, 2007.
6. Kamper D G and Rymer W Z, “Impairment of voluntary control of finger motion following stroke: Role of inappropriate muscle coactivation,” Muscle Nerve, vol. 24, no. 5, pp. 673-681, May 2001.
7. Kamper D G, Fischer H C, Cruz E G, and Rymer W Z, “Weakness is the primary contributor to finger impairment in chronic stroke,” Arch. Phys. Med. Rehabil, vol. 87, no. 9, pp. 1262-1269, 2006.
8. Huang V S and Krakauer J W, “Robotic neurorehabilitation: A computational motor learning perspective,” J. Neuroeng. Rehabil, vol. 6, no. 1, p. 5, December. 2009.
9. Mehrholz J, Pohl M, Platz T, Kugler J, and Elsner B, “Electromechanical and robot-assisted arm training for improving activities of daily living, arm function, and arm muscle strength after stroke,” Cochrane Database Syst. Rev, vol. 9, no. 9, September. 2018, Art. no. CD006876.
10. Lum P S, Mulroy S, Amdur R L, Requejo P, Prilutsky B I, and Dromerick A W, “Gains in upper extremity function after stroke via recovery or compensation: Potential differential effects on amount of real-world limb use,” Topics Stroke Rehabil, vol. 16, no. 4, pp. 237-253, 2009.
11. Thielbar K O et al., “Benefits of using a voice and EMG-driven actuated glove to support occupational therapy for stroke survivors,” IEEE Trans. Neural Syst. Rehabil. Eng, vol. 25, no. 3, pp. 297-305, March. 2017, doi: 10.1109/tnsre.2016.2569070.
12. Kim G J, Taub M, Creelman C, Cahalan C, O'Dell M W, and Stein J, “Feasibility of an electromyography-triggered hand robot for people after chronic stroke,” Amer. J. Occupational Therapy, vol. 73, no. 4, pp. 7304345040p1-7304345040p9, July-August 2019, doi: 10.5014/ajot.2019.030908.
13. Huang Y, Lai W P, Qian Q, Hu X, Tam E W C, and Zheng Y, “Translation of robot-assisted rehabilitation to clinical service: A comparison of the rehabilitation effectiveness of EMG-driven robot hand assisted upper limb training in practical clinical service and in clinical trial with laboratory conFIGuration for chronic stroke,” Biomed. Eng. OnLine, vol. 17, no. 1, p. 91, June. 2018, doi: 10.1186/s12938-018-0516-2.
14. Fischer H C et al., “Use of a portable assistive glove to facilitate rehabilitation in stroke survivors with severe hand impairment,” IEEE Trans. Neural Syst. Rehabil. Eng, vol. 24, no. 3, pp. 51-344, March. 2016, doi: 10.1109/TNSRE.2015.2513675.
15. Farrell J F, Hoffman H B, Snyder J L, Giuliani C A, and Bohannon R W, “Orthotic aided training of the paretic upper limb in chronic stroke: Results of a phase 1 trial,” NeuroRehabilitation, vol. 22, no. 2, pp. 99-103, June. 2007.
16. Ates S, Lobo-Prat J, Lammertse P, van der Kooij H, and Stienen A H, “SCRIPT passive orthosis: Design and technical evaluation of the wrist and hand orthosis for rehabilitation training at home,” in Proc. IEEE 13th Int. Conf Rehabil. Robot. (ICORR), June. 2013, pp. 1-6.
17. Brokaw E B, Black I, Holley R J, and Lum P S, “Hand spring operated movement enhancer (HandSOME): A portable, passive hand exoskeleton for stroke rehabilitation,” IEEE Trans. Neural Syst. Rehabil. Eng, vol. 19, no. 4, pp. 391-399, August. 2011.
18. Chen J, Nichols D, Brokaw E B, and Lum P S, “Home-based therapy after stroke using the hand spring operated movement enhancer (HandSOME),” IEEE Trans. Neural Syst. Rehabil. Eng, vol. 25, no. 12, pp. 2305-2312, December. 2017.
19. Chen T and Lum P S, “Hand rehabilitation after stroke using a wearable, high DOF, spring powered exoskeleton,” in Proc. 38th Annu. Int. Conf IEEE Eng. Med. Biol. Soc. (EMBC), August. 2016, pp. 578-581, doi: 10.1109/embc.2016.7590768.

What is claimed is:

1. A wearable device comprising:
an exoskeleton configured to attach to a hand of a user,
wherein the exoskeleton comprises one or more finger linkages for respective fingers of the hand; and
a finger attachment configured to slide onto each finger and attached to the respective one or more finger linkages;
wherein the one or more finger linkages comprises a metacarpophalangeal (MCP) joint linkage and proximal interphalangeal (PIP) joint linkage,
wherein the one or more finger linkages couples the metacarpophalangeal (MCP) joint linkage and proximal interphalangeal (PIP) joint linkage together so that movement is restricted to one degree of freedom (DOF).

2. The wearable device of claim 1, wherein rotation of the metacarpophalangeal (MCP) joint and proximal interphalangeal (PIP) joint is configured to be coupled.

3. The wearable device of claim 2, wherein rotation of the metacarpophalangeal (MCP) joint and proximal interphalangeal (PIP) joint achieves a torque capacity, wherein the torque capacity is adjusted by selection of different finger linkages.

4. The wearable device of claim 1, wherein the one or more finger linkages comprises elastic bands.

5. The wearable device of claim 4, wherein the elastic bands are configured to drive both the metacarpophalangeal (MCP) joint and proximal interphalangeal (PIP) joint together.

6. The wearable device of claim 1, wherein the device is passively powered.

7. The wearable device of claim 1, wherein the finger attachment comprises a quick-connect and quick-release function for connecting to the respective one or more finger linkages and/or disconnecting from the respective one or more finger linkages.

8. The wearable device of claim 7, wherein the quick-connect and quick-release function comprises a snap.

9. The wearable device of claim 1, wherein a rotation of the quick-connect and quick-release function comprises a snap.

10. The wearable device of claim 1, wherein the exoskeleton is configured with one or more sensors including a magnetometer, an accelerometer, a potentiometer, and/or a bend sensor.

11. A wearable device comprising:
an exoskeleton configured to attach to a hand of a user,
wherein the exoskeleton comprises one or more finger linkages for respective fingers of the hand; and
a finger attachment configured to slide onto each finger and attached to the respective one or more finger linkages;
wherein the one or more finger linkages comprises a metacarpophalangeal (MCP) joint linkage and proximal interphalangeal (PIP) joint linkage,
wherein the one or more finger linkages couples the metacarpophalangeal (MCP) joint linkage and proximal interphalangeal (PIP) joint linkage together so that movement is restricted to one degree of freedom (DOF),
wherein the finger attachment comprises a quick-connect and quick-release function for connecting to the respective one or more finger linkages and/or disconnecting from the respective one or more finger linkages.

12. The wearable device of claim 11, wherein rotation of the metacarpophalangeal (MCP) joint and proximal interphalangeal (PIP) joint is configured to be coupled.

13. The wearable device of claim 12, wherein rotation of the metacarpophalangeal (MCP) joint and proximal interphalangeal (PIP) joint achieves a torque capacity, wherein the torque capacity is adjusted by selection of different finger linkages.

14. The wearable device of claim 11, wherein the one or more finger linkages comprises elastic bands.

15. The wearable device of claim 14, wherein the elastic bands are configured to drive both the metacarpophalangeal (MCP) joint and proximal interphalangeal (PIP) joint together.

16. The wearable device of claim 11, wherein the device is passively powered.

17. The wearable device of claim 11, wherein the finger attachment comprises a quick-connect and quick-release function for connecting to the respective finger linkage and/or disconnecting from the respective finger linkage.

18. The wearable device of claim 11, wherein the quick-connect and quick-release function comprises a snap.

19. The wearable device of claim 11, wherein the exoskeleton is configured with one or more sensors including a magnetometer, an accelerometer, a potentiometer, and/or a bend sensor.

20. A method of donning a wearable device comprising:
attaching an exoskeleton to the hand of a user,
wherein the exoskeleton comprises one or more finger linkages for respective fingers of the hand;
inserting fingers into a respective finger attachment; and
connecting the finger attachment to the one or more finger linkages;
wherein the one or more finger linkages comprises a metacarpophalangeal (MCP) joint linkage and proximal interphalangeal (PIP) joint linkage,
wherein the one or more finger linkages couples the metacarpophalangeal (MCP) joint linkage and proximal interphalangeal (PIP) joint linkage together so that movement is restricted to one degree of freedom (DOF).

21. The method of claim 20, wherein the finger attachment comprises a quick-connect and quick-release function for connecting to the respective one or more finger linkages and/or disconnecting from the respective one or more finger linkages.

22. The method of claim 21, wherein the quick-connect and quick-release function comprises a snap.

23. The method of claim 20, comprising:
coupling the metacarpophalangeal (MCP) joint and proximal interphalangeal (PIP) joint during rotation.

24. The method of claim 20, wherein a torque capacity is adjusted by selecting different finger linkages.

25. The method of claim 20, wherein the one or more finger linkages comprises elastic bands.

26. The method of claim 25, comprising:
configuring the elastic bands to drive both the metacarpophalangeal (MCP) joint and proximal interphalangeal (PIP) joint together.

27. The method of claim 20, comprising:
passively powering the wearable device.

28. The method of claim 20, wherein the exoskeleton is configured with one or more sensors including a magnetometer, an accelerometer, a potentiometer, and/or a bend sensor.
